(19) United States
(12) Patent Application Publication
(10) Pub. No.: US 2023/0251098 A1
(43) Pub. Date: Aug. 10, 2023

(54) INFORMATION PROCESSING APPARATUS, MOBILE-BODY CONTROL SYSTEM, AND INFORMATION PROCESSING METHOD

(71) Applicant: NEC CORPORATION, Minato-ku, Tokyo (JP)

(72) Inventor: Yuichi YANO, Tokyo (JP)

(73) Assignee: NEC Corporation, Minato-ku, Tokyo (JP)

(21) Appl. No.: 18/011,703

(22) PCT Filed: May 17, 2021
(86) PCT No.: PCT/JP2021/018665

§ 371 Date: Dec. 20, 2022

(30) Foreign Application Priority Data
Jun. 30, 2020 (JP) 2020-112327

(51) Int. Cl. G01C 21/34; G01C 21/20

(52) U.S. Cl. CPC G01C 21/3446; G01C 21/206; G01C 21/3407

(57) ABSTRACT

A traveling route along which a target mobile body can perform radio communication is determined. An information processing apparatus includes a traveling route determination unit, a traveling plan acquisition unit, a map information acquisition unit, and a communication channel determination unit. The traveling route determination unit determines a traveling route for a first mobile body. The traveling plan acquisition unit acquires a traveling route for a second mobile body and a radio communication channel used by the second mobile body at each point on the traveling route based on the determined result. The map information acquisition unit acquires map information indicating, for each part of a facility in which the second mobile body can move, a communication failure area corresponding to the radio communication channel that is used by the second mobile body. The communication channel determination unit determines the communication failure area corresponding to the radio communication channel.

### TECHNICAL FIELD

The present invention relates to an information processing apparatus, a mobile-body control system, and an information processing method.

### BACKGROUND ART

Automatic guided vehicles (AGVs: Automatic Guided Vehicles) controlled through radio communication with a control system have been installed in factories and warehouses. The sizes of warehouses and factories are large and a number of apparatuses and cargos, which interfere with radio waves, are installed or placed therein. Therefore, in some cases, it is difficult to install wireless access points in a warehouse or a factory in such a manner that the radio waves can reach every nook and corner thereof. Further, since the situation of a factory or a warehouse changes on a daily basis, the strength of radio waves at each part of the factory or the warehouse also changes on a daily basis. Therefore, in some cases, the strength of radio waves on a traveling route of an AGV becomes weak and the communication quality thereof deteriorates, thus bringing the AGV to a standstill or making it uncontrollable.

For example, Patent Literature 1 discloses a mobile-body remote control system including detection means for detecting at least a position of a mobile body in an area corresponding to map information based on sensor information from a sensor, and control information creation means for creating control information for controlling the mobile body so as to avoid a radio communication failure in a communication failure area, based on at least the map information, hypothetical obstacle information, and a result of the detection by the detection means.

### CITATION LIST

### Patent Literature

### Patent Literature 1: Japanese Unexamined Patent Application Publication No. 2012-137909

### SUMMARY OF INVENTION

### Technical Problem

When a plurality of AGVs are traveling, radio communication of a given AGV may be interfered with by that of another AGV. In that case, the given AGV may come to a standstill or become uncontrollable. Further, there is a problem that when an AGV travels while detecting and avoiding a communication failure area caused by another AGV, the AGV performs a number of wasteful evasive traveling movements, so that its operational efficiency deteriorates.

The present invention has been made to solve the above-described problems, and an object thereof is to provide an information processing apparatus, a mobile-body control system, and an information processing method capable of determining, for a target mobile body, a traveling route along which the mobile body can perform radio communication.

### Solution to Problem

An information processing apparatus according to a first aspect of the present disclosure includes:

a traveling route determination unit configured to determine a traveling route for a first mobile body;

a traveling plan acquisition unit configured to acquire a traveling route for a second mobile body and a radio communication channel used by the second mobile body at each point on the traveling route based on the determined result;

a map information acquisition unit configured to acquire map information indicating, for each part of a facility in which the second mobile body can move, a communication failure area corresponding to the radio communication channel that is used by the second mobile body when the second mobile body is located at that part of the facility; and

a communication channel determination unit configured to determine the communication failure area corresponding to the radio communication channel, caused by the second mobile body in the traveling route for the first mobile body, and determine a radio communication channel available to the first mobile body based on the determined communication failure area.

A mobile-body control system according to a second aspect of the present disclosure includes:

a first mobile body and a second mobile body, each of which uses a radio communication channel; and

a control apparatus configured to control the first mobile body, in which

the control apparatus includes:

a traveling route determination unit configured to determine a traveling route for the first mobile body;

a traveling plan acquisition unit configured to acquire a traveling route for the second mobile body and the radio communication channel used by the second mobile body at each point on the traveling route based on the determined result;

a map information acquisition unit configured to acquire map information indicating, for each part of a facility in which the second mobile body can move, a communication failure area corresponding to the radio communication channel that is used by the second mobile body when the second mobile body is located at that part of the facility; and

a communication channel determination unit configured to determine the communication failure area corresponding to the radio communication channel, caused by the second mobile body in the traveling route for the first mobile body, and determine a radio communication channel available to the first mobile body based on the determined communication failure area.

An information processing method according to a third aspect of the present disclosure includes:

determining a traveling route for a first mobile body;

acquiring a traveling route for a second mobile body and a radio communication channel used by the second mobile body at each point on the traveling route based on the determined result;

acquiring map information indicating, for each part of a facility in which the second mobile body can move, a communication failure area corresponding to the radio communication channel that is used by the second mobile body when the second mobile body is located at that part of the facility; and

determining the communication failure area corresponding to the radio communication channel, caused by the second mobile body in the traveling route for the first mobile body, and determining a radio communication channel available to the first mobile body based on the determined communication failure area.

### Advantageous Effects of Invention

According to the present disclosure, it is possible to provide an information processing apparatus, a mobile-body control system, and an information processing method capable of determining, for a target mobile body, a traveling route along which the mobile body can perform radio communication.

### BRIEF DESCRIPTION OF DRAWINGS

FIG. 1 is a block diagram showing a configuration of an information processing apparatus according to a first example embodiment;

FIG. 2 is a flowchart showing an information processing method according to the first example embodiment;

FIG. 3 is a block diagram showing a configuration of a mobile-body control system according to a second example embodiment;

FIG. 4 is a diagram for explaining an example of a grid map according to a third example embodiment;

FIG. 5 is a diagram for explaining a radio-wave strength map when an automatic guided vehicle according to the third example embodiment uses a radio channel 1;

FIG. 6 is a diagram for explaining a radio-wave strength map when the automatic guided vehicle according to the third example embodiment uses a radio channel 2;

FIG. 7 is a block diagram showing a configuration of a mobile-body control system according to the third example embodiment;

FIG. 8 is a flowchart showing operations performed by the mobile-body control system according to the third example embodiment;

FIG. 9 is a diagram for explaining symbols used in specific examples shown in FIGS. 10 and 14 according to the third example embodiment;

FIG. 10A shows diagrams for explaining changes over time in a radio-wave strength map of the radio communication channels 1 and 2 according to the third example embodiment;

FIG. 10B shows diagrams for explaining changes over time in a radio-wave strength map of the radio communication channels 1 and 2 according to the third example embodiment;

FIG. 10C shows diagrams for explaining changes over time in a radio-wave strength map of the radio communication channels 1 and 2 according to the third example embodiment;

FIG. 10D shows diagrams for explaining changes over time in a radio-wave strength map of the radio communication channels 1 and 2 according to the third example embodiment;

FIG. 11 shows tables showing examples of traveling plans for automatic guided vehicles A1 and A2 according to the third example embodiment;

FIG. 12 is a table showing an example of a traveling plan for an automatic guided vehicle A3 according to the third example embodiment;

FIG. 13 is a flowchart showing operations performed by a mobile-body control system according to a fourth example embodiment;

FIG. 14A shows diagrams for explaining another example of changes over time in the radio-wave strength map of radio communication channels 1 and 2 according to the fourth example embodiment;

FIG. 14B shows diagrams for explaining another example of changes over time in the radio-wave strength map of radio communication channels 1 and 2 according to the fourth example embodiment;

FIG. 14C shows diagrams for explaining another example of changes over time in the radio-wave strength map of radio communication channels 1 and 2 according to the fourth example embodiment;

FIG. 15 shows tables showing examples of traveling plans for automatic guided vehicles A1 and A2 according to the fourth example embodiment;

FIG. 16 is a table showing an example of a traveling plan for an automatic guided vehicle A3 according to the fourth example embodiment; and

FIG. 17 is a block diagram for explaining an example of a hardware configuration of an information processing apparatus 10.

### EXAMPLE EMBODIMENT

### First Example Embodiment

An example embodiment according to the present invention will be described hereinafter with reference to the drawings.

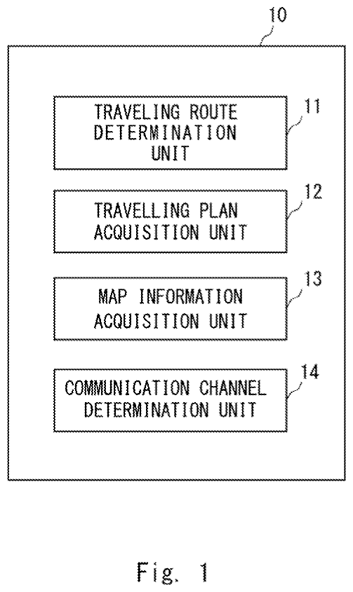

FIG. 1 is a block diagram showing a configuration of an information processing apparatus according to a first example embodiment.

The information processing apparatus 10 can be used to determine a traveling route for a mobile body and a radio communication channel available to the mobile body in the determined traveling route. The information processing apparatus 10 can be implemented by a computer. The information processing apparatus 10 includes a traveling route determination unit 11, a traveling plan acquisition unit 12, a map information acquisition unit 13, and a communication channel determination unit 14.

The traveling route determination unit 11 determines a traveling route for a first mobile body. Examples of the mobile body include a variety of objects, such as a vehicle, a robot, and an airplane, that can move under remote control. A person(s) may or may not be on/in the mobile body. The traveling route determination unit 11 may determine a traveling start time and a scheduled traveling end time for the first mobile body. When the traveling route determination unit 11 receives, for example, a destination for the first mobile body, it can determine the shortest route from the current position of the first mobile body to the destination as an initial traveling route.

The traveling plan acquisition unit 12 acquires a traveling route for a second mobile body and a radio communication channel used by the second mobile body at each point on the traveling route based on the result determined by the traveling route determination unit 11. The second mobile body can be one mobile body or a plurality of mobile bodies. The traveling route for the second mobile body and the radio communication channel used at each point on the traveling route are stored in a traveling plan storage unit disposed inside the information processing apparatus or stored in an external apparatus connected thereto through a network.

The map information acquisition unit 13 acquires map information that indicates, for each part of the facility in which the second mobile body can move, a communication failure area corresponding to the radio communication channel that is used by the second mobile body when the second mobile body is located at that part of the facility. The communication failure area used in this specification means an area where the strength of radio waves is weaker than a threshold and hence a mobile body cannot perform communication. The layout of the facility may be divided into a plurality of grids. The size of each grid may correspond to the size of the mobile body. In the map information, a communication failure area or a communication possible area is indicated on a grid-by-grid basis. The map information is stored in a map information storage unit disposed inside the information processing apparatus or in an external apparatus connected thereto through a network.

The communication channel determination unit 14 determines a communication failure area corresponding to the radio communication channel, caused by the second mobile body in the traveling route for the first mobile body, and determines a radio communication channel available to the first mobile body based on the determined communication failure area.

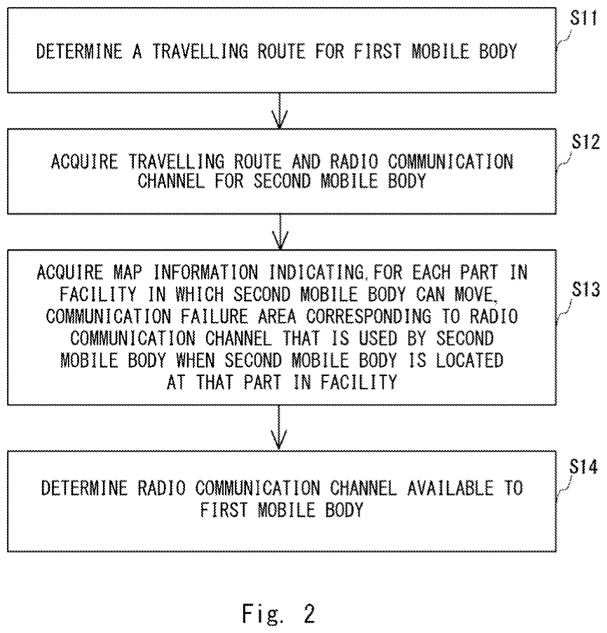

FIG. 2 is a flowchart showing an information processing method according to the first example embodiment.

The traveling route determination unit 11 determines a traveling route for the first mobile body (Step S11). The traveling plan acquisition unit 12 acquires a traveling route for the second mobile body and a radio communication channel used by the second mobile body at each point on the traveling route based on the result determined by the traveling route determination unit 11 (Step S12). The map information acquisition unit 13 acquires map information indicating, for each part of the facility in which the second mobile body can move, a communication failure area corresponding to the radio communication channel used by the second mobile body when the second mobile body is located at that part of the facility (Step S13). The communication channel determination unit 14 determines a communication failure area corresponding to the radio communication channel, caused by the second mobile body in the traveling route for the first mobile body, and determines a radio communication channel available to the first mobile body based on the determined communication failure area (Step S14).

According to the above-described first example embodiment, it is possible to determine a traveling route for a target mobile body (e.g., the first mobile body) and a radio communication channel available thereto while taking the traveling route(s) and the radio communication channel(s) for another mobile body(ies) (e.g., the second mobile body and the like), and a communication failure area(s) that could be caused by the other mobile body(ies) into consideration.

### Second Example Embodiment

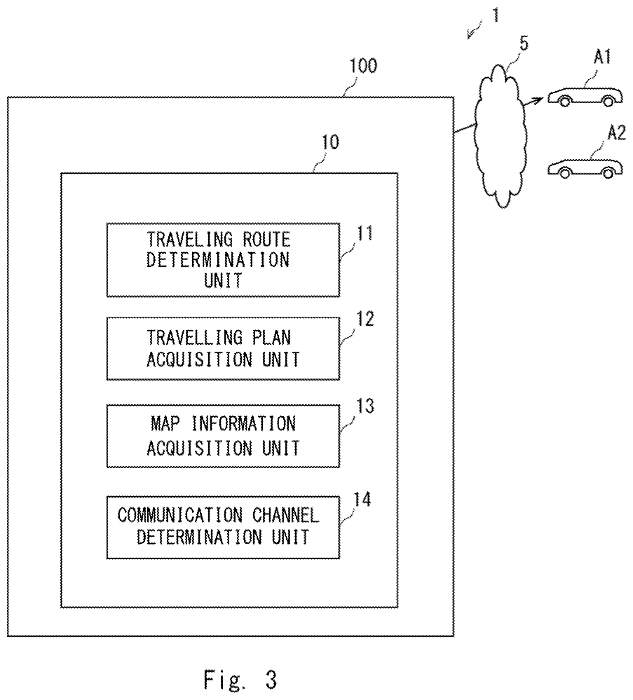

FIG. 3 is a block diagram showing a configuration of a mobile-body control system 1 according to a second example embodiment.

The mobile-body control system 1 includes a first mobile body A1 and a second mobile body A2, each of which uses a radio communication channel, and a control apparatus 100 which controls the first mobile body A1 (and the second mobile body A2). The control apparatus 100 includes an information processing apparatus 10 according to the first example embodiment. That is, the control apparatus 100 includes: a traveling route determination unit 11 that determines a traveling route for the first mobile body A1;

a traveling plan acquisition unit 12 that acquires a traveling route for the second mobile body A2 and the radio communication channel used by the second mobile body A1 at each point on the traveling route based on the determined result;

a map information acquisition unit 13 that acquires map information indicating, for each part of a facility in which the second mobile body A2 can move, a communication failure area corresponding to the radio communication channel that is used by the second mobile body A2 when the second mobile body A2 is located at that part of the facility; and

a communication channel determination unit 14 that determines the communication failure area corresponding to the radio communication channel, caused by the second mobile body A2 in the traveling route for the first mobile body A1, and determines a radio communication channel available to the first mobile body A1 based on the determined communication failure area.

According to the above-described second example embodiment, it is possible to determine a traveling route for a target mobile body (e.g., the first mobile body) and a radio communication channel available thereto while taking the traveling route(s) and the radio communication channel(s) for another mobile body(ies) (e.g., the second mobile body and the like), and a communication failure area(s) that could be caused by the other mobile body(ies) into consideration, and to control the target mobile body according to the determined traveling plan.

### Third Example Embodiment

The mobile-body control system 1 remotely controls at least one mobile body (e.g., an automatic guided vehicle) disposed in a facility such as a warehouse and a factory through a network. The network includes a plurality of access points each of which wirelessly connects to the mobile body. The automatic guided vehicle (AGV) includes a radio interface that supports a plurality of radio communication channels. Similarly, each of the access points supports a plurality of radio communication channels. The channels include, for example, but are not limited to, an 80 MHz channel and a 160 MHz channel in IEEE 802.11ac (Wi-Fi5). For example, various channels such as other IEEE 802.11 methods, 4G, 5G (Local 5G), and LTE (Long Term Evolution) may be used.

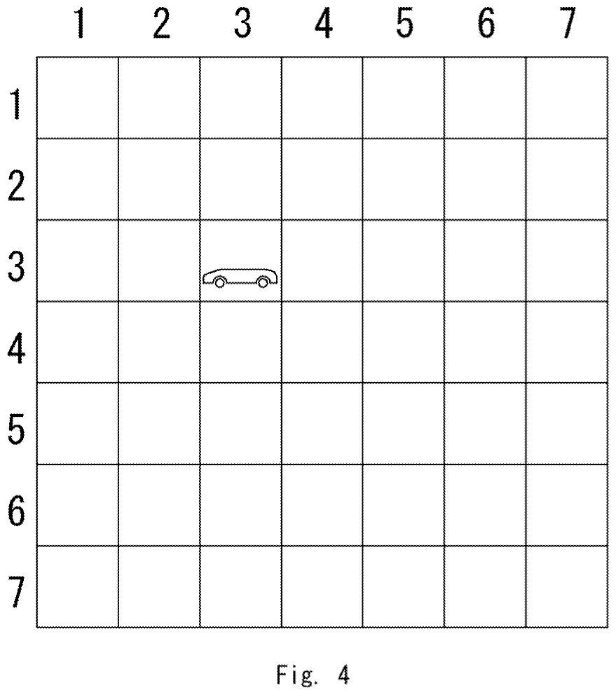

FIG. 4 is a diagram for explaining an example of a grid map. The grid map is a map in which the layout of the facility is divided into a plurality of grids (divided into 7×7 grids in FIG. 4). FIG. 4 shows a square layout, and indicates that an automatic guided vehicle (also called a transport robot) can move all the grids in the layout while being able to perform radio communication. Note that the transport robot shown in FIG. 4 can move up, down, left, and right along grids. The layout of the facility in the present disclosure is not limited to the square, but may be a layout having various shapes including a rectangular shape and a circular shape. Further, although all the grids are identical square grids in FIG. 4, they may be rectangular (non-square) grids or grids having other suitable shapes. Further, the grid map may also include at least one grid including a physical obstacle that the automatic guided vehicle cannot travel over (e.g., a wall, a fixed object, or the like) or an area where the automatic guided vehicle cannot perform communicate (e.g., a weak radio-wave area where the strength of radio waves is lower than a threshold). The mobile-body control system 1 holds the grid map in a storage unit (also called a map information database) and can manage the position of the AGV and the traveling route therefor on a grid-by-grid basis. The size of one grid may be defined so that one AGV is contained in one grid, or is smaller than the size of one AGV so that one AGV occupies a plurality of grids.

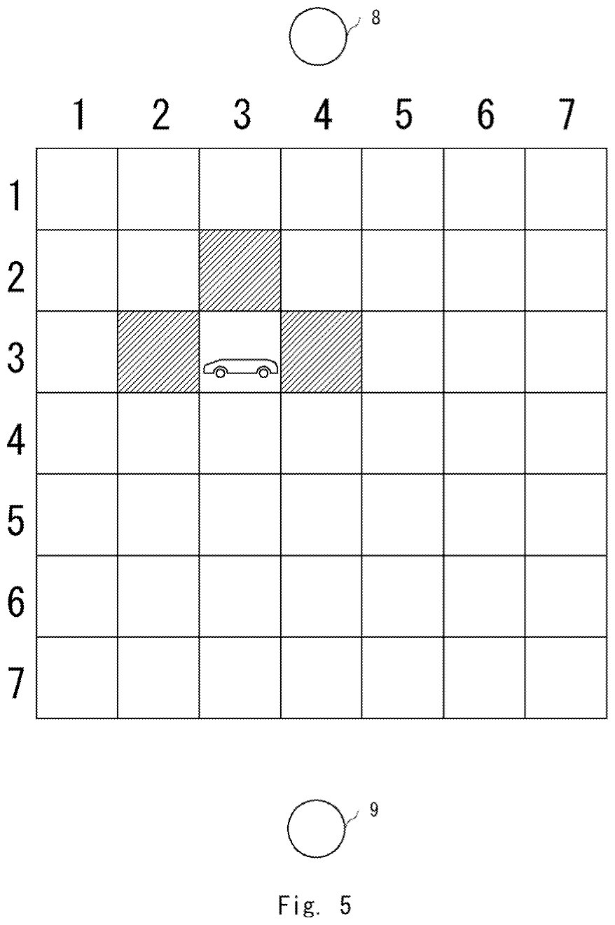

FIG. 5 is a diagram for explaining a radio-wave strength map when the automatic guided vehicle according to the third example embodiment uses a radio channel 1. The radio-wave strength map shows, on the above-described grid map, areas where the strength of radio waves is weaker than a threshold and hence the automatic guided vehicle cannot perform communication (hereafter also referred to as communication failure areas or weak radio-wave areas). As for the method for predicting and measuring the strength of radio waves, a known method such as a method disclosed in Japanese Unexamined Patent Application Publication No. 2012-137909 can be used. The communication failure area(s) for the radio channel 1 that is caused by an automatic guided vehicle when the automatic guided vehicle is located in a given grid is detected in advance. In this example, when the automatic guided vehicle uses the radio channel 1, it uses an access point 9 located on one side of the facility (on the lower side in FIG. 5). As shown in FIG. 5, when the automatic guided vehicle is located in a grid (3, 3), grids located in front of and behind the aforementioned grid in the traveling direction of the automatic guided vehicle, and a grind located to the right of the aforementioned grid, i.e., grids (2, 3), (4, 3) and (3, 2) are defined as communication failure areas. As described above, the automatic guided vehicle moves to all the grids while using the radio channel 1, and by doing so, for each grid, a radio-wave strength map showing communication failure areas for the radio channel 1 caused when the automatic guided vehicle is located at that grid is prepared.

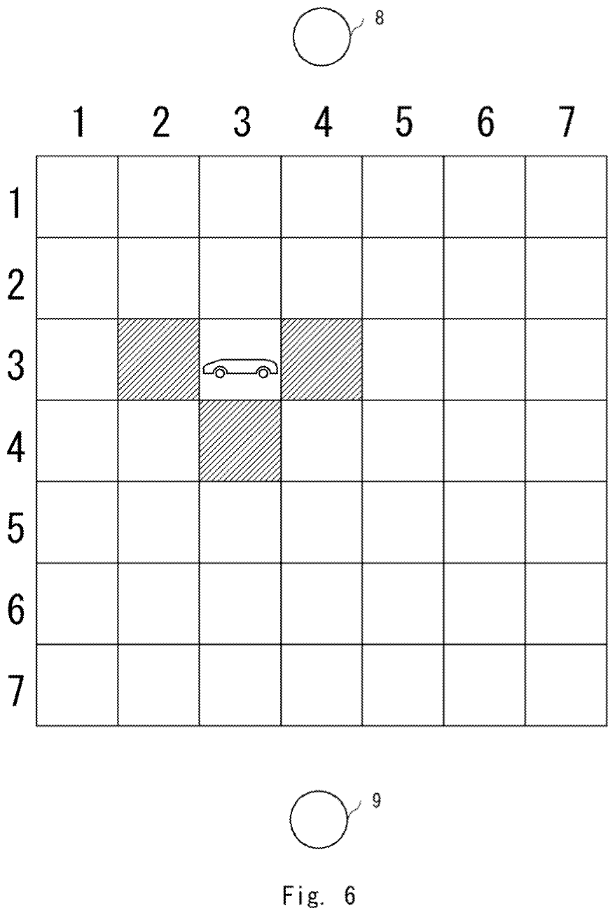

FIG. 6 is a diagram for explaining a radio-wave strength map when the automatic guided vehicle according to the third example embodiment uses a radio channel 2. When the automatic guided vehicle uses the radio channel 2, it uses an access point 8 located on the other side of the facility (on the upper side in FIG. 6). As shown in FIG. 6, when the automatic guided vehicle is located in a grid (3, 3), grids located in front of and behind the aforementioned grid in the traveling direction of the automatic guided vehicle, and a grind located to the left of the aforementioned grid, i.e., grids (2, 3), (4, 3) and (3, 4) are defined as communication failure areas for the radio channel 2. As described above, the automatic guided vehicle moves to all the grids (except for grids in which there are physical obstacles) while using the radio channel 2, and by doing so, for each grid, a radio-wave strength map showing communication failure areas for the radio channel 2 caused when the automatic guided vehicle is located at that grid is prepared. All the radio-wave strength maps each of which is created for a respective one of a plurality of channels as described above are stored in the storage unit (the map information database).

For the efficiency of the operation, when a plurality of automatic guided vehicles are identical to each other or similar to each other, it is sufficient if radio-wave strength maps for one automatic guided vehicle are prepared. Automatic guided vehicles identical to each other or similar to each other are, for example, automatic guided vehicles which have shapes identical to each other or similar to each other, structures identical to each other or similar to each other, and/or product numbers identical to each other or similar to each other, so that they may cause communication failure areas identical to each other or similar to each other. On the other hand, when a plurality of automatic guided vehicles have shapes different from each other, or structures different from each other, communication failure areas caused by these automatic guided vehicles may different from each other. Therefore, radio-wave strength maps may be separately prepared for each of the automatic guided vehicles. Further, in the above-described example, radio-wave strength maps for two different radio channels are created. When there are three or more radio channels, radio-wave strength maps are prepared in advance for each of the radio channels. Further, although only two access points are shown for simplifying the explanation in the above-described example, three or more access points may be provided. The mobile-body control system holds radio-wave strength maps in the storage unit (the map information database), so that the mobile-body control system can refer to the radio-wave strength maps when it determines a traveling route for a mobile body. Further, in some cases, the communication environment of the facility change. Therefore, the radio-wave strength maps may be periodically updated by periodically performing measurements. For example, the strength of radio waves at each grid may be measured in advance, e.g., at the start of a daily operation, by having all the automatic guided vehicles travel the grids. Further, the strength of radio waves at each grid may be measured at a predetermined time (e.g., 12:00) by having all the automatic guided vehicles travel the grids. The strength of radio waves at each grid may be measured at regular intervals (e.g., every six hours) by having all the automatic guided vehicles travel the grids.

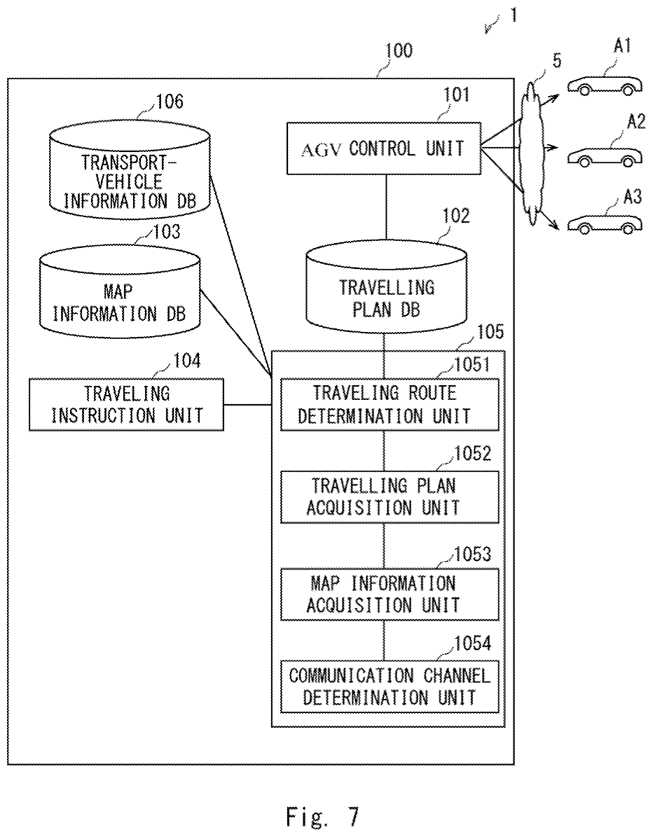

FIG. 7 is a block diagram showing an example of a configuration of the mobile-body control system 1 that controls mobile bodies.

The mobile-body control system 1 includes an information processing apparatus (a control apparatus 100) implemented by at least one computer, and a plurality of mobile bodies (A1 to A3 in FIG. 7) connected to the information processing apparatus through a network 5. The mobile-body control system 1 includes an AGV control unit 101, a traveling plan database 102, a map information database 103, a traveling plan determination unit 105, and a traveling instruction unit 104. Note that the traveling plan determination unit 105 may be implemented by one information processing apparatus, and the AGV control unit 101 may be implemented by another information processing apparatus.

The AGV control unit 101 controls each of the automatic guided vehicles according to its traveling plan stored in the traveling plan database 102. The AGV control unit 101 controls the traveling of the automatic guided vehicle by wirelessly communicating with the automatic guided vehicle through an access point connected thereto through a network. As the traveling plan, the traveling plan database 102 stores, for each automatic guided vehicle and for each grid along the traveling route therefor, a traveling route for that automatic guided vehicle and a radio channel used by the automatic guided vehicle when it is located at that grid. Further, a transport-vehicle information database 106 can store characteristics (e.g., a moving speed) of each automatic guided vehicle and the size thereof. The traveling plan database is also called a traveling plan storage unit.

The map information database 103 stores the above-described grid maps and the radio-wave strength maps. The map information database is also called a map information storage unit. One of the features of the present disclosure is to determine an appropriate traveling route and an appropriate communication channel by referring to the radio-wave strength map including communication failure areas for each radio communication channel, caused by a mobile body. When the traveling instruction unit 104 receives an input of a destination of an automatic guided vehicle by an operator or the like, it instructs the traveling plan determination unit 105 to determine a traveling plan for this automatic guided vehicle concerned.

The traveling plan database 102, the transport-vehicle information database 106, and the map information database 103 may be disposed inside the control apparatus 100 or outside the control apparatus 100 (e.g., on the cloud side). All the functions may be provided in one apparatus or may be provided in separate apparatuses. An edge-side apparatus can determine a traveling plan by referring to a database on the cloud side. For example, an edge computer may summarize information about the automatic guided vehicles A1 and A2, and send the information processed in the edge computer to the cloud side.

The traveling plan determination unit 105 includes a traveling route determination unit 1051, a traveling plan acquisition unit 1052, a map information acquisition unit 1053, and a communication channel determination unit 1054. Firstly, the traveling route determination unit 1051 receives a destination (and a traveling start time) for a target automatic guided vehicle from the traveling instruction unit 104. The traveling route determination unit 1051 determines a traveling route (also called an initial traveling route) to the destination of the target automatic guided vehicle, for which it has received the destination. For example, the traveling route determination unit 1051 may determine the shortest route from the current position of the automatic guided vehicle to the destination as the traveling route. The traveling route determination unit 1051 may determine the initial route so as to avoid physical obstacles shown on the grid map. That is, the initial traveling route does not necessarily have to be a straight route and may be a shortest zigzag route. The traveling route determination unit 1053 may determine the traveling route as appropriate so that the cost, the electric power, the distance, and/or the time are minimized. Further, the traveling route determination unit 1051 may determine a traveling start time.

The traveling plan acquisition unit 1052 acquires, from the traveling plan database 102, a grid position at each time point (each unit time point) (i.e., a traveling route) of other automatic guided vehicles and a radio communication channel used at each grid during the period from the traveling start time of the target automatic guided vehicle to the traveling end time thereof.

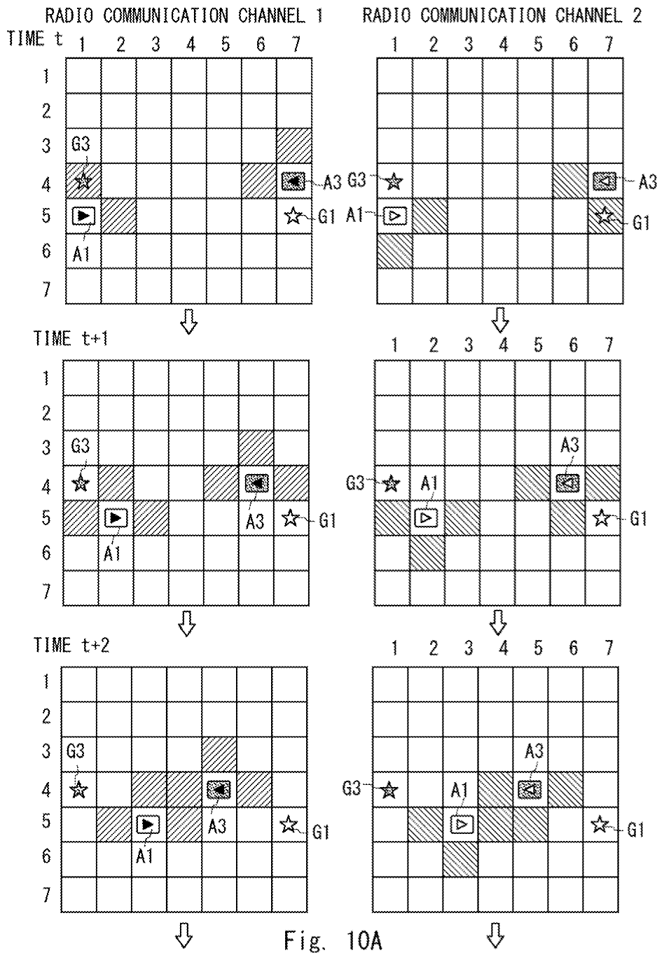

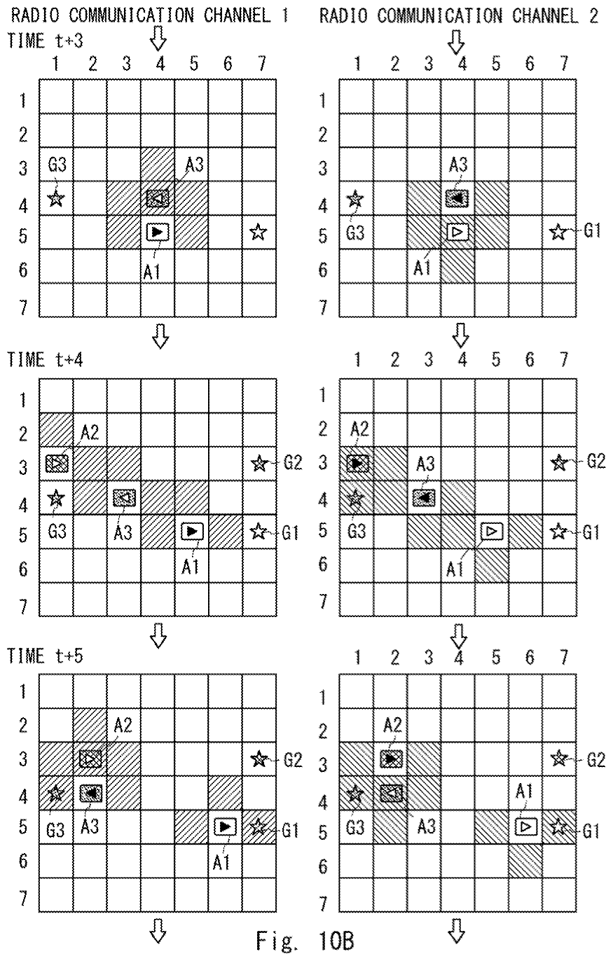

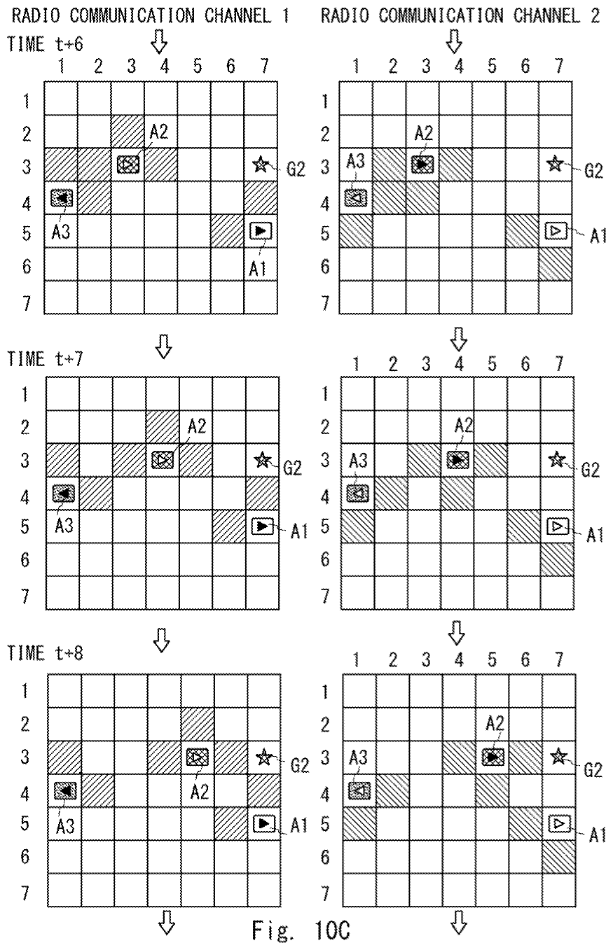

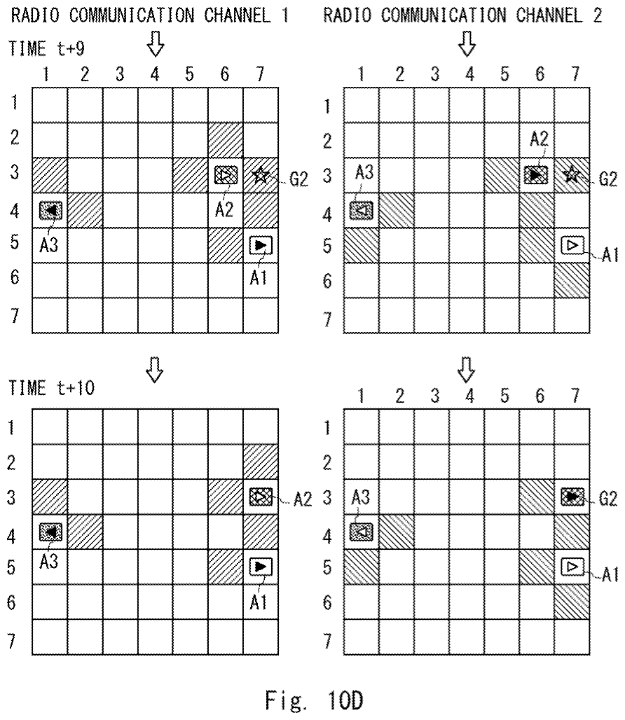

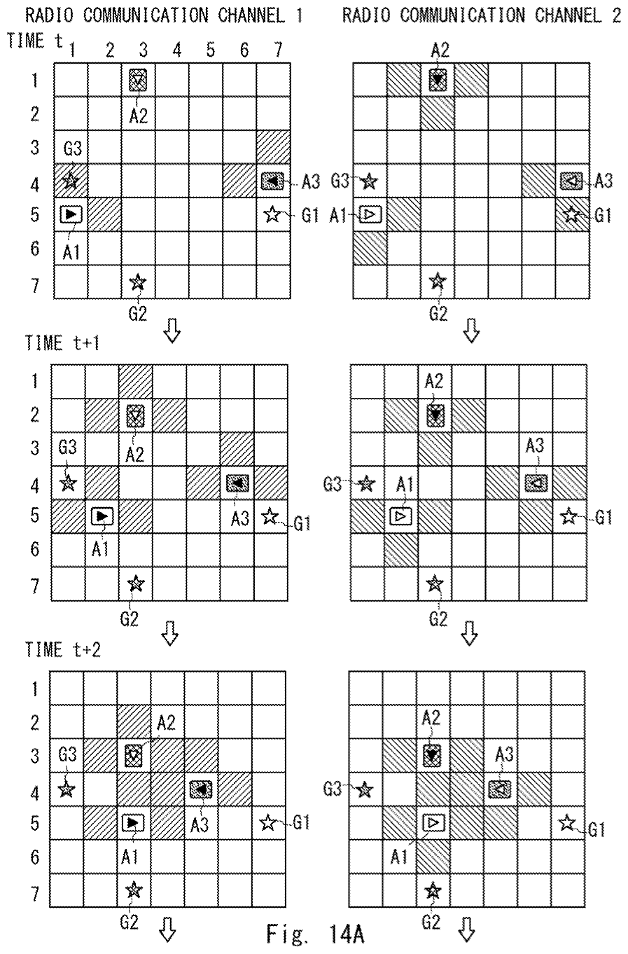

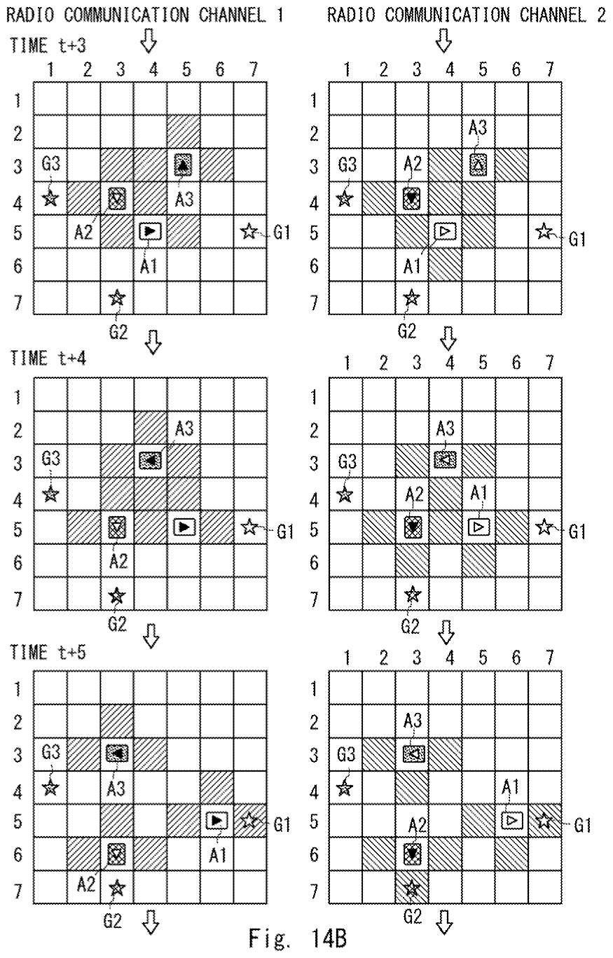

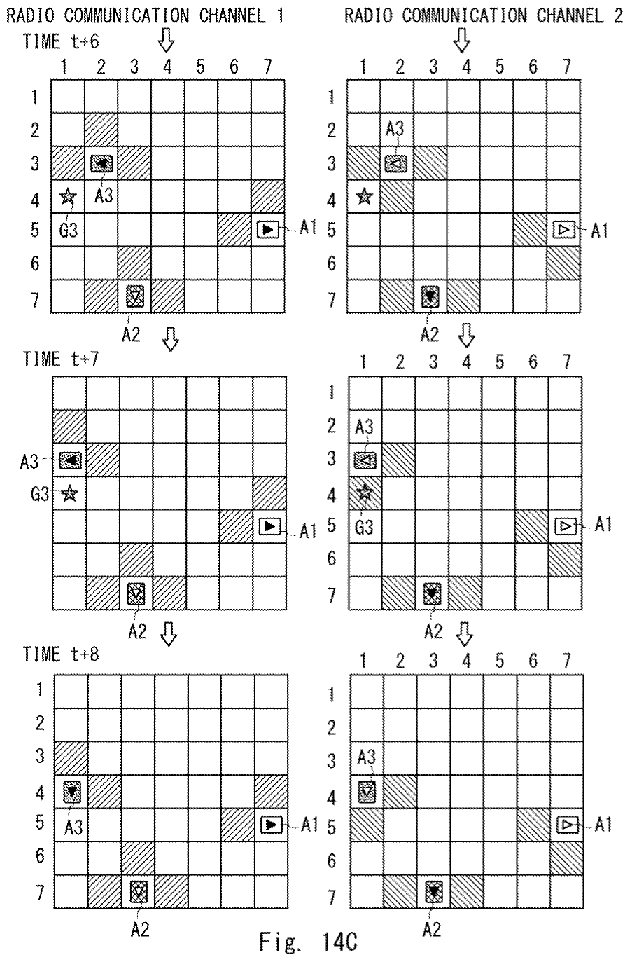

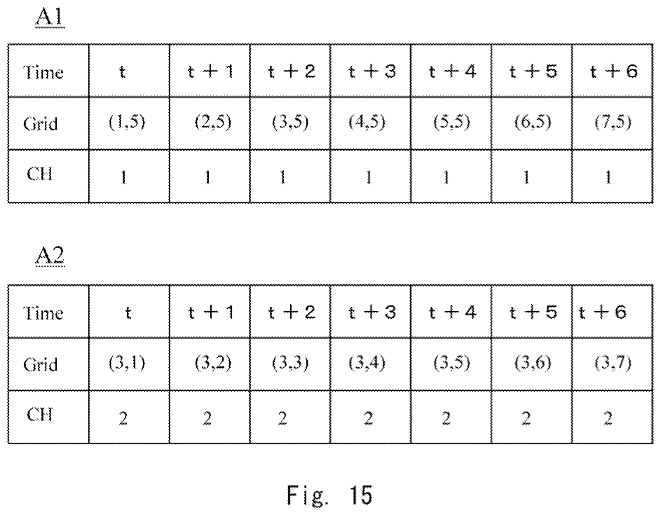

The map information acquisition unit 1053 acquires map information indicating a communication failure area and a communication possible area at each grid position of the other automatic guided vehicles in the traveling routes for the other automatic guided vehicles. Further, the map information acquisition unit 1052 also acquire map information for all the channels available to the target automatic guided vehicle. The map information acquisition unit 1053 can also create a composite map at each time point (FIGS. 10 and 14) for each radio channel (e.g., in this example, each of the radio channels 1 and 2) for the target automatic guided vehicle and the other automatic guided vehicles.

The communication channel determination unit 1054 determines a radio communication channel used by the target automatic guided vehicle at each grid in the traveling route (the initial traveling route) determined by the traveling route determination unit 1051. Specifically, the communication channel determination unit 1054 determines a radio communication channel used by the target automatic guided vehicle by referring to the traveling routes of the other automatic guided vehicles stored in the traveling route database 102, and the radio-wave strength map showing communication failure areas stored in the map information database 103. When the communication channel determination unit 1054 cannot find any radio communication channel through which it can communicate with the target automatic guided vehicle at any of the grids, the communication channel determination unit 1054 instructs the traveling route determination unit 1051 to determine a traveling route (also called a detour route) again. The map information acquisition unit 1053 determines a traveling route in such a manner that the target automatic guided vehicle avoids the communication failure areas caused by other automatic guided vehicles and the communication failure areas that could be caused by the target automatic guided vehicle do not interfere with the communication of the other automatic guided vehicles. In this case, the traveling route determination unit 1053 can determine a detour route so as to find a radio communication channel that can be used at all the grids by increasing the cost using A* (A-star) or the like.

Note that the traveling route determination unit 1051 can also determine the traveling route for the target automatic guided vehicle while taking the traveling routes and the like of the other automatic guided vehicles stored in the traveling plan database 102 into consideration (i.e., so as not to collide with any of the other automatic guided vehicles). Further, the traveling route determination unit 1053 can also determine the traveling route for the target automatic guided vehicle so as to avoid physical obstacles shown on the grid map.

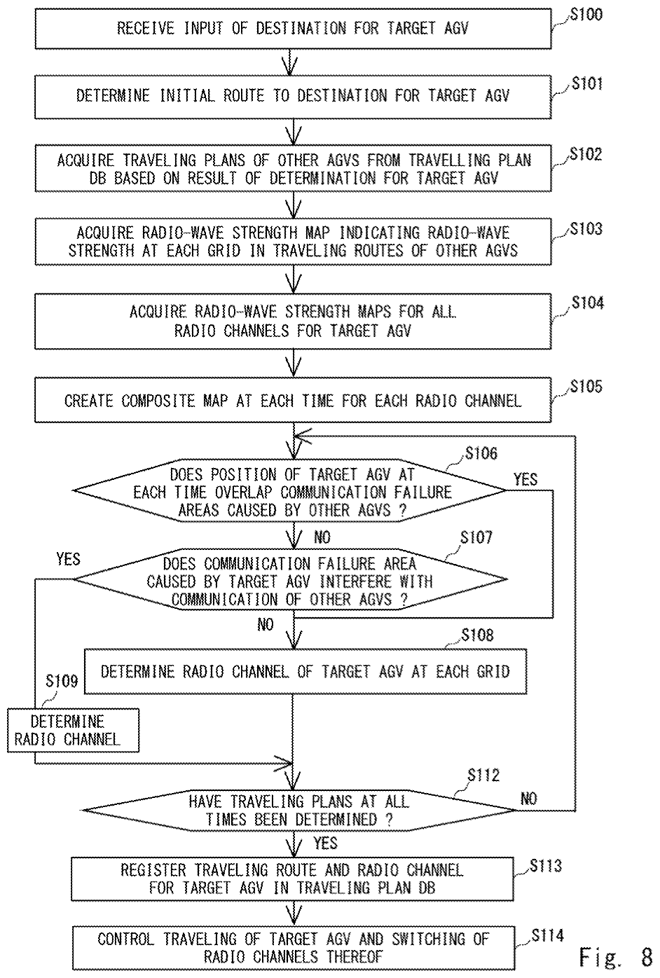

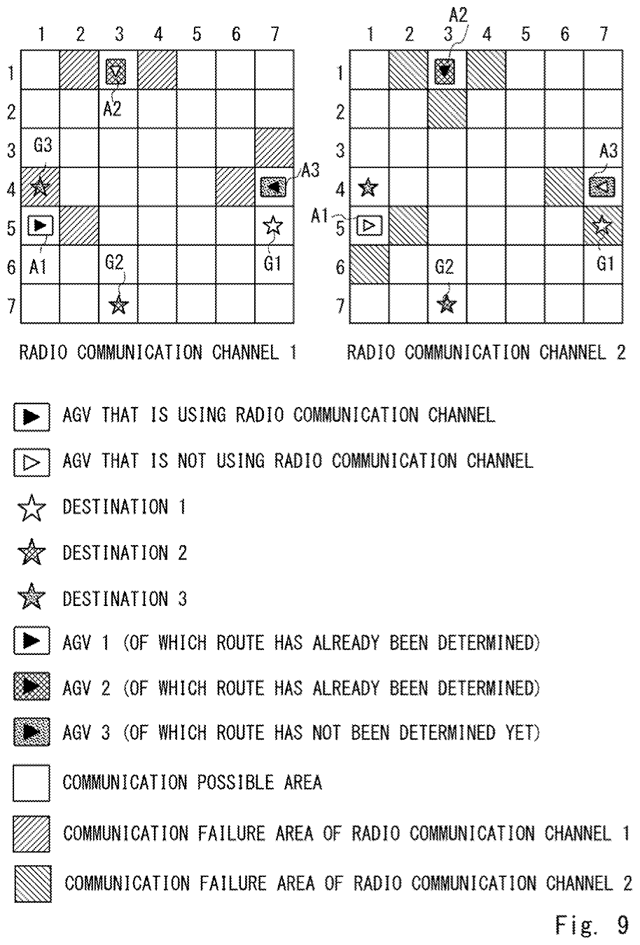

Next, operations performed by the mobile-body control system 1 will be described with reference to a flowchart shown in FIG. 8 and with reference to FIGS. 9 to 12.

FIG. 8 is a flowchart showing operations performed by the mobile-body control system according to the third example embodiment. FIG. 9 is a diagram for explaining symbols used in the specific examples shown FIG. 10 (FIGS. 10A to 10D) and FIG. 14 (FIGS. 14A to 14C). In each of the right and left parts in FIG. 9, three automatic guided vehicles A1, A2 and A3 are shown. In each of the right and left parts in FIG. 9, the goals (the destinations) of the three automatic guided vehicles A1, A2 and A3 are indicated by symbols (asterisks) G1, G2 and G3. Since the left and right parts in FIG. 9 show maps at the same time point, the positions of the three automatic guided vehicles A1, A2 and A3 in both parts are the same as each other. Note that in FIGS. 9, 10 and 14, for the sake of explanation, it is assumed that the three automatic guided vehicles A1, A2 and A3 are of the same type as each other, have shapes and structures identical to each other, and move at speeds equal to each other. However, the automatic guided vehicles A1, A2 and A3 may be of types different from each other, have shapes and structures different from each other, and/or move at speeds different from each other.

Meanwhile, the left part in FIG. 9 is for a radio communication channel 1 and the right part in FIG. 9 is for a radio communication channel 2. As described above, since communication failure areas caused by automatic guided vehicles are different from one radio communication channel to another, the left and right parts in FIG. 9 show communication possible areas (blank grids) different from each other and communication failure areas (hatched grids) different from each other. An example in which the traveling routes and the radio communication channels for the automatic guided vehicles A1 and A2 (also referred to as other mobile bodies in the specification) have already been determined, and a traveling route and a radio communication channel for the automatic guided vehicle A3 (also referred to as the target mobile body in the specification) of which the goal (the destination) has already been set to a point G3 will be determined will be described hereinafter.

As shown in FIG. 8, the traveling plan determination unit 105 receives a destination of the automatic guided vehicle A3 from the traveling instruction unit 104 (e.g., through an input of an operator the like) (Step S100). The traveling plan determination unit 105 starts a process for determining the traveling plan for the automatic guided vehicle A3 to the destination, which starts at a predetermined traveling start time. Alternatively, the traveling plan determination unit 105 may receive the destination and the traveling start time of the automatic guided vehicle A3 from the traveling instruction unit 104 through an input of an operator the like.

The traveling route determination unit 1051 determines the shortest route from the current position of the automatic guided vehicle A3 to the destination as an initial route (Step S101). In the example shown in FIG. 10 (FIGS. 10A to 10D), it is assumed that the straight route from a grid (7, 4) to a grid (1, 4) is determined as the initial route, and that the automatic guided vehicle A3 starts traveling at a time t. The traveling route determination unit 1051 can determine a scheduled traveling end time by using the initial route and the speed of the automatic guided vehicle A3 (acquired from the automatic guided vehicle database).

The traveling plan acquisition unit 1052 acquires traveling plans for the other automatic guided vehicles A1 and A2 based on the result of the determination for the automatic guided vehicle A3 made by the traveling route determination unit 1053 (Step S102). Specifically, the traveling plan acquisition unit 1052 reads, from the traveling plan database 102, the grid positions of the other automatic guided vehicles A1 and A2 at each time point (each unit time point) and the radio communication channels to be used by them during the period from the traveling start time of the target automatic guided vehicle A3 to the scheduled traveling end time thereof. Note that the scheduled traveling end time may be set while taking the case where (i.e., possibility that) the target automatic guided vehicle does not travel along the initial route but travels along a detour route into consideration.

The map information acquisition unit 1053 acquires a radio-wave strength map at each grid for the other automatic guided vehicles in the traveling route for the other automatic guided vehicles (Step S103). Specifically, the map information acquisition unit 1052 acquires, from the map information database 103, for each grid in the traveling route for each of the other automatic guided vehicles A1 and A2 and for each radio communication channel, a radio-wave strength map for the automatic guided vehicle corresponding to that radio communication channel when the automatic guided vehicle is located at that grid.

Further, the map information acquisition unit 1053 also acquires radio-wave strength maps for all radio channels (in this example, for the radio channels 1 and 2) for the target automatic guided vehicle A3 (Step S 104). These radio-wave strength maps can be used when it is determined whether the communication failure area caused by the target automatic guided vehicle A3 will interfere with the communication of the other automatic guided vehicles.

In this way, the map information acquisition unit 1052 creates a composite map at each time point for each radio channel (each of the radio channels 1 and 2) for each of the automatic guided vehicles (i.e., each of the other automatic guided vehicles A1 and A2, and for the target automatic guided vehicle A3) (Step S105). FIGS. 10A to 10D show the created composite maps. FIGS. 10A to 10D show the positions of the automatic guided vehicles A1, A2 and A3 at times t to t+10, and the communication failure areas for the two communication channels, i.e., the radio communication channels 1 and 2, in a side-by-side manner.

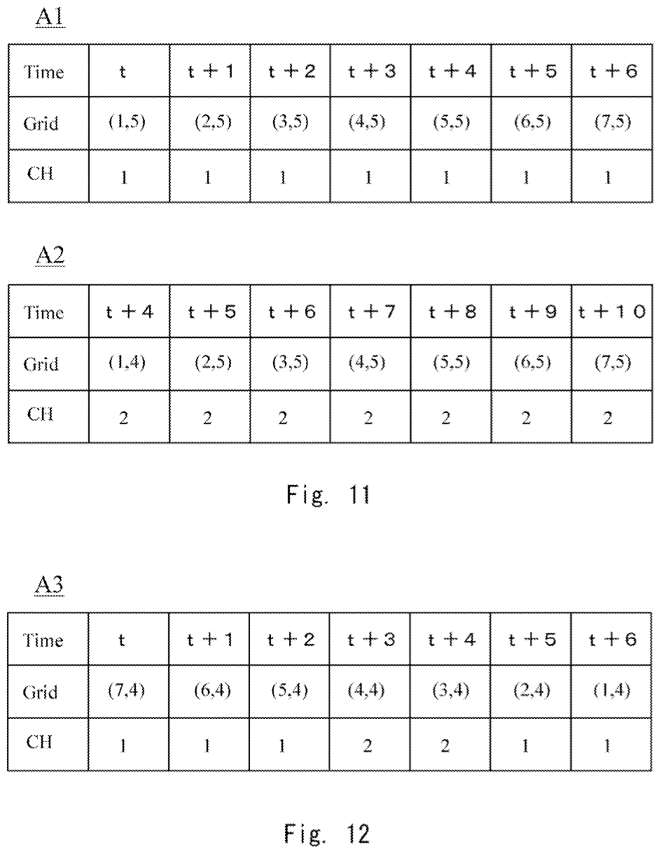

In the example shown in FIGS. 10A to 10D, the traveling plans for the automatic guided vehicles A1 and A2 have already been determined and stored in the traveling plan database 102. That is, it has already been determined that the automatic guided vehicle A1 will travel from a grid (1, 5) to a grid (7, 5) while using the radio communication channel 1 from times t to t+6, and the automatic guided vehicle A2 will travel from a grid (1, 3) to a grid (7, 3) while using the radio communication channel 2 from times t+4 to t+10, and information about them is stored in the traveling plan database 102. FIG. 11 shows tables showing examples of the traveling plans for the automatic guided vehicles A1 and A2. In the table, for each of the automatic guided vehicles, the position of a grid at each time point and a radio channel (CH) used at each grid (i.e., at that grid) are shown.

The traveling plan for the target automatic guided vehicle A3 will be examined hereinafter. In this example, a traveling route and a radio communication channel(s) for the automatic guided vehicle A3 from a grid (7, 4) to a grid (1, 4) are determined while setting its traveling start time to a time t. In the example shown in FIGS. 10A to 10D, a straight route from the grid (7, 4), which is the current position, to the grid (1, 4), which is the destination, has already been determined as the initial route. Note that the traveling route determination unit 1051 may determine the initial route so as to avoid physical obstacles shown on the grid map. That is, the initial route does not necessarily have to be a straight route and may be a shortest zigzag route.

Next, the communication channel determination unit 1054 determines a radio communication channel for the automatic guided vehicle A3 based on the map information indicating communication failure areas caused by the other automatic guided vehicles. Specifically, the communication channel determination unit 1054 examines whether or not each of the grids along the initial route for the automatic guided vehicle A3 overlaps any of the communication failure areas of the other automatic guided vehicles on the radio-wave strength maps (Step S 106).

In times t to t+2, as shown in FIG. 10A, the automatic guided vehicle A3 does not overlap any of the communication failure areas caused by the other automatic guided vehicles regardless of whether it uses the radio communication channel 1 or 2. Further, the communication failure area caused by the automatic guided vehicle A3 does not interfere with the communication of the other automatic guided vehicles A1 and A2 regardless of whether it uses the radio communication channel 1 or 2 (No at Step S107). In this example, the communication channel determination unit 1054 determines the radio communication channel 1 as the radio communication channel used by the automatic guided vehicle A3 (Step S108).

At a time t+3, the automatic guided vehicle A3 overlaps the communication failure area for the radio communication channel 1 caused by the automatic guided vehicle A1 at a grid (4, 4) (Yes at Step S106). Since the automatic guided vehicle A3 does not overlap the communication failure area for the radio communication channel 2 at the time t+3 in FIG. 10B, at this stage, the communication channel determination unit 1054 determines that the automatic guided vehicle A3 should perform switching so as to use the radio communication channel 2 (Step S108). Further, the communication failure area for the radio communication channel 2 caused by the automatic guided vehicle A3 overlaps the position of the automatic guided vehicle A1. However, since the automatic guided vehicle A1 is performing communication by using the radio communication channel 1, the communication of the automatic guided vehicle A1 is not interfered with by that of the automatic guided vehicle A3.

Regarding a time t+4, when the automatic guided vehicle A3 moves to a grid (3, 4), it determines to continue using the radio communication channel 2 (Step S108).

At a time t+5, the automatic guided vehicle A3 overlaps the communication failure area for the communication channel 2 caused by the automatic guided vehicle A2 at a grid (2, 4) at which the automatic guided vehicle A3 is located (Yes at Step S106). Since the automatic guided vehicle A3 does not overlap the communication failure area for the radio communication channel 1 at the time t+5 in FIG. 10B, at this stage, the communication channel determination unit 1054 determines that the automatic guided vehicle A3 performs switching so as to use the radio communication channel 1 (Step S108). Further, the communication failure area for the communication channel 1 caused by the automatic guided vehicle A3 overlaps the position of the automatic guided vehicle A2. However, since the automatic guided vehicle A2 is performing communication by using the radio communication channel 2, the communication of the automatic guided vehicle A2 is not interfered with by that of the automatic guided vehicle A3.

At a time t+6, when the automatic guided vehicle A3 moves to a grid (1, 4), it determines to continue using the radio communication channel 1 (Step S108). As described above, the traveling plan for the automatic guided vehicle A3 at all of the time points is determined (Yes at Step S112).

As described above, the traveling route and the radio communication channels for the automatic guided vehicle A3 are determined. When the radio communication channel for the automatic guided vehicle A3 at each grid has been successfully determined (Step S108) and the traveling plan at all of the time points has been determined (Yes at Step S112), the traveling plan determination unit 105 registers the determined traveling route and the radio channel at each grid for the automatic guided vehicle A3 in the traveling plan database 102 (Step S113).

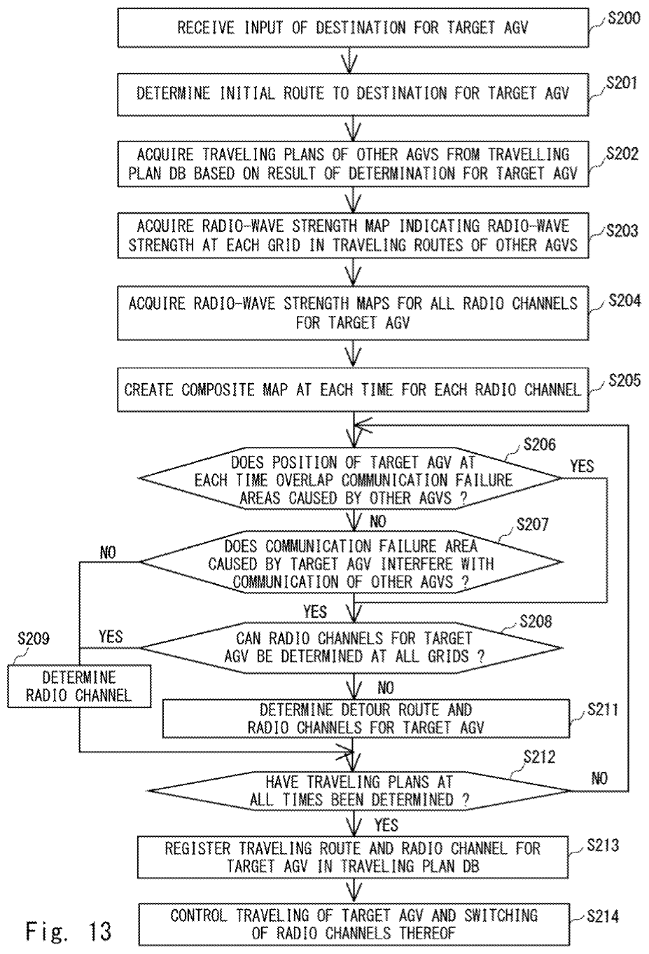

FIG. 12 is a table showing an example of a traveling plan for the automatic guided vehicle A3. In the table, for each of the automatic guided vehicles, the position of a grid at each time point and a radio channel (CH) used at each grid (i.e., at that grid) are shown. Tables each of which is like the one shown in FIG. 12 are stored in the traveling plan database 102.

The AGV control unit 101 reads the traveling plans for the automatic guided vehicles A1, A2 and A3 from the traveling plan database 102, and controls the traveling of each of the automatic guided vehicles and the switching of the radio channel therefor according to the plan (Step S114).

According to the above-described third example embodiment, it is possible to appropriately determine a traveling route and a radio communication channel(s) for the target automatic guided vehicle. Further, the mobile-body control system 1 can efficiently control the traveling of the automatic guided vehicle and the switching of communication channel therefor according to the determined traveling plan.

In the above-described example, an example in which a radio channel available to the automatic guided vehicle A3 can be found at every grid in the initial route (the shortest route) for the automatic guided vehicle A3 has been described.

### Fourth Example Embodiment

Next, another specific example will be described with reference to a flowchart shown in FIG. 13 and with reference to FIGS. 14A to 14C. FIG. 13 is a flowchart showing operations performed by a mobile-body control system according to a fourth example embodiment.

A traveling plan for the automatic guided vehicle A3 will be examined hereinafter.

The traveling plan determination unit 105 receives the destination of the automatic guided vehicle A3 from the traveling instruction unit 104 through an input of an operator the like (Step S200). Upon receiving the destination, the traveling plan determination unit 105 starts a process for determining the traveling plan for the automatic guided vehicle A3 to the destination, which starts at a traveling start time immediately after the reception. Alternatively, the traveling plan determination unit 105 may receive the destination and the traveling start time of the automatic guided vehicle A3 from the traveling instruction unit 104 through an input of an operator the like.

The traveling route determination unit 1051 determines the shortest route from the current position of the automatic guided vehicle A3 to the destination as an initial route (Step S201). In the example shown in FIG. 14 (FIGS. 14A to 14C), it is assumed that the straight route for the automatic guided vehicle A3 from a grid (7, 4) to a grid (1, 4) is determined as the initial route, and that the automatic guided vehicle A3 starts traveling at a time t. The traveling route determination unit 1051 can determine a scheduled traveling end time by using the initial route and the speed of the automatic guided vehicle A3 (acquired from the automatic guided vehicle database).

The traveling plan acquisition unit 1052 acquires traveling plans for the other automatic guided vehicles A1 and A2 based on the result of the determination for the automatic guided vehicle A3 by made by the traveling route determination unit 1051 (Step S202). Specifically, the traveling plan acquisition unit 1052 reads, from the traveling plan database 102, the grid positions of the other automatic guided vehicles A1 and A2 at each time point (each unit time point) and the radio communication channels to be used by them during the period from the traveling start time of the target automatic guided vehicle A3 to the scheduled traveling end time thereof. Note that the scheduled traveling end time may be set while taking the case where (i.e., possibility that) the target automatic guided vehicle does not travel along the initial route but travels along a detour route into consideration.

The map information acquisition unit 1053 acquires a radio-wave strength map at each grid for the other automatic guided vehicles in the traveling route for the other automatic guided vehicles (Step S203). Specifically, the map information acquisition unit 1053 acquires, from the map information database 103, for each grid in the traveling route for each of the other automatic guided vehicles A1 and A2 and for each radio communication channel, a radio-wave strength map for the automatic guided vehicle corresponding to that radio communication channel when the automatic guided vehicle is located at that grid.

Further, the map information acquisition unit 1053 also acquires radio-wave strength maps of all radio channels (in this example, for the radio channels 1 and 2) for the target automatic guided vehicle A3 (Step S204).

The map information acquisition unit 1052 creates a composite map at each time point for each radio channel (each of the radio channels 1 and 2) for each of the automatic guided vehicles (i.e., each of the other automatic guided vehicles A1 and A2, and for the target automatic guided vehicle A3) (Step S205). FIGS. 14A to 14C show the created composite maps. FIGS. 14A to 14C show radio-wave strength maps for two communication channels, i.e., the radio communication channels 1 and 2, for the automatic guided vehicles A1, A2 and A3 at times t to t+8 in a side-by-side manner.

In the example shown in FIGS. 14A to 14C, the traveling plans for the automatic guided vehicles A1 and A2 have already been determined and stored in the traveling plan database 102. That is, it has already been determined that the automatic guided vehicle A1 will travel from a grid (1, 5) to a grid (7, 5) while using the radio communication channel 1 from times t to t+6, and the automatic guided vehicle A2 will travel from a grid (3, 1) to a grid (3, 7) while using the radio communication channel 2 from the times t to t+6, and information about them is stored in the traveling plan database 102. FIG. 15 shows tables showing examples of the traveling plans for the automatic guided vehicles A1 and A2. In the table, for each of the automatic guided vehicles, the position of a grid at each time point and a radio channel (CH) used at each grid (i.e., at that grid) are shown.

The traveling plan for the target automatic guided vehicle A3 will be examined hereinafter. In this example, a traveling route and a radio communication channel(s) for the automatic guided vehicle A3 from a grid (7, 4) to a grid (1, 4) are determined while setting its traveling start time to a time t. In the example shown in FIG. 14, a straight route from the grid (7, 4), which is the current position, to the grid (1, 4), which is at the destination, has already been set as the initial route. Note that traveling plan determination unit 105 may determine the initial route so that the automatic guided vehicle A3 does not collide with the other automatic guided vehicles A1 and A2. Further, the traveling plan determination unit 105 may determine the initial route so as to avoid physical obstacles shown on the grid map. That is, the initial route does not necessarily have to be a straight route and may be a shortest zigzag route.

Next, the communication channel determination unit 1054 determines a radio communication channel for the automatic guided vehicle A3 based on the map information indicating communication failure areas caused by the other automatic guided vehicles. Specifically, the communication channel determination unit 1054 examines whether or not each of the grids along the initial route for the automatic guided vehicle A3 overlaps any of the communication failure areas for the other automatic guided vehicles on the radio-wave strength maps (Step S206).

In times t to t+2, as shown in FIG. 14A, the automatic guided vehicle A3 does not overlap any of the communication failure areas caused by the other automatic guided vehicles regardless of whether it uses the radio communication channel 1 or 2. Further, the communication failure area caused by the automatic guided vehicle A3 does not interfere with the communication of the other automatic guided vehicles A1 and A2 regardless of whether it uses the radio communication channel 1 or 2 (No at Step S207). In this example, the communication channel determination unit 1054 determines the radio communication channel 1 as the radio communication channel used by the automatic guided vehicle A3 (Step S209).

In the initial route from the grid (7, 4) to the grid (1, 4), the automatic guided vehicle A3 is supposed (i.e., planned) to travel through the grid (4, 4) at the time t+3, but the grid (4, 4) is a communication failure area for both the radio communication channels 1 and 2 at the time t+3 (Yes at Step S206). Further, when the automatic guided vehicle A3 moves to the grid (4, 4) at the time t+3, it will also interfere with the communication channel 2 used by the automatic guided vehicle A2 (Yes at Step S207). That is, for the automatic guided vehicle

A3, the communication channel determination unit 1054 cannot find any available radio channel at the grid (4, 4) in the initial route (No at Step S208).

Therefore, the traveling route determination unit 1051 determines a detour route and a radio channel(s) with which the automatic guided vehicle A3 avoids the communication failure areas caused by the automatic guided vehicle A1 and A2 and the communication failure area caused by the automatic guided vehicle A3 does not interfere with the communication of the other automatic guided vehicles A1 and A2 (Step S211). It is determined that the automatic guided vehicle A3 should move to a grid (5,3) at the time t+3. In this case, the traveling route determination unit 1053 can determine a detour route so as to find radio communication channels that can be used at all the grids by increasing the cost using A* (A-star) or the like.

As shown in FIGS. 14B and 14C, the detour route is determined so that, in times t+4 to t+7, the automatic guided vehicle A3 will successively move to the left grid, and at a time t+8, the automatic guided vehicle A3 will reach the grid (1, 4), which is the destination. Throughout this period, the position of the automatic guided vehicle A3 does not overlap any of the communication failure areas for the radio communication channels 1 and 2 caused by the automatic guided vehicle A1 and A2. Further, the communication failure areas for the radio communication channels 1 and 2 caused by the automatic guided vehicle A3 do not interfere with the communication of the other automatic guided vehicles A1 and A2. Therefore, in this example, the communication channel determination unit 1054 determines that the automatic guided vehicle A3 should use the radio channel 1.

As described above, when the communication channel determination unit 1054 cannot find any radio communication channel by which the automatic guided vehicle can perform communication at any of the grids in the shortest route (No at Step S208), the communication channel determination unit 1054 can instruct the traveling route determination unit 1053 to determine the traveling route again (Step S211).

As described above, the traveling route and the radio communication channels for the automatic guided vehicle A3 are determined. When the radio communication channels for the automatic guided vehicle A3 at all the grids in the detour route to the destination have been determined (Step S211) and the traveling plan at all the time points has been determined (Yes at Step S212), the traveling plan determination unit 105 registers the determined traveling route and the radio channel for the automatic guided vehicle A3 at each grid in the traveling plan database 102 (Step S213).

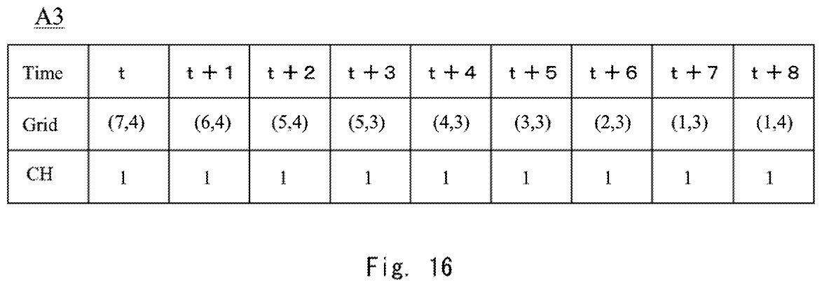

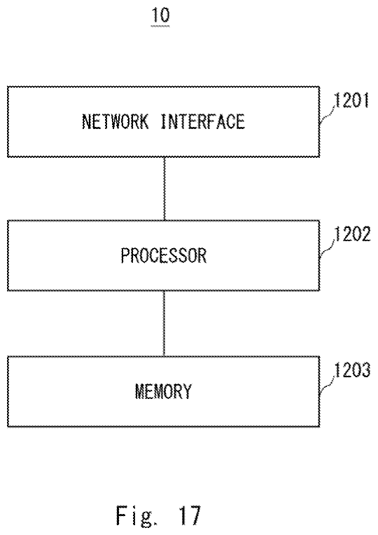

FIG. 16 is a table showing an example of a traveling plan for the automatic guided vehicle A3 according to the third example embodiment. In the table, for each automatic guided vehicle A3, the position of a grid at each time point and a radio channel (CH) used at each grid (i.e., at that grid) are shown. Tables each of which is like the one shown in FIG. 16 are stored in the traveling plan database 102.

The AGV control unit 101 reads the traveling plans for the automatic guided vehicles A1, A2 and A3 from the traveling plan database 102, and controls the traveling of each of the automatic guided vehicles and the switching of the radio channel therefor according to the plan (Step S214).

As described above, it is possible to calculate a route for avoiding a grid(s) in a communication failure area(s) by increasing the cost of the grid(s) in the communication failure area(s) at each time point by using an algorithm such as A* for the calculation of the route.

According to the above-described fourth example embodiment, it is possible to appropriately determine a traveling route and a radio communication channel(s) for the target automatic guided vehicle. Further, the mobile-body control system 1 can efficiently control the traveling of the automatic guided vehicle and the switching of communication channel therefor according to the determined traveling plan.

According to the above-described example embodiment, by preparing a plurality of radio communication channels, measuring, for each part of the facility, the strength of radio waves of each communication channel when an AGV travels that part of the facility, and referring to the measured strengths and the like when a route is calculated, it is possible to perform route calculation in which the effect of the radio communication of other AGVs on that of the AGV of interest (e.g., the target AGV) and the effect of the radio communication of the AGV of interest on those of the other AGVs are predicted. It is possible to enable a plurality of AGVs to travel in a stable and efficient manner by calculating, in advance, routes that avoid communication failure areas while switching radio communication channels. In the above-described mobile-body control system, the amount of calculation processing can be reduced by managing the traveling route and the strength of radio waves on a grid-by-grid basis.

In each of the flowcharts shown in FIGS. 8 and 13, a specific execution order is shown. However, the execution order may be changed from the order shown in the flowchart. For example, the execution order of two or more steps may be interchanged from the order shown in the flowchart. Further, two or more consecutive steps shown in FIG. 8 or 13 may be executed simultaneously or partially simultaneously with each other. Further, in some of the example embodiments, one or a plurality of steps shown in FIG. 8 or 13 may be skipped or omitted.

FIG. 17 is a block diagram showing an example of a hardware configuration of each of the information processing apparatus 10 and the control apparatus 100 (hereinafter also referred to as the information processing apparatus 10 or the like). Referring to FIG. 17, the information processing apparatus 10 or the like includes a network interface 1201, a processor 1202, and a memory 1203. The network interface 1201 is used to communicate with other network node apparatuses which constitutes a communication system. The network interface 1201 may be used to perform wireless communication. For example, the network interface 1201 may be used to perform wireless LAN communication specified in IEEE 802.11 series or mobile communication specified in 3GPP (3rd Generation Partnership Project). Alternatively, the network interface 1201 may include, for example, a network interface card (NIC) in conformity with IEEE 802.3 series.

The processor 1202 performs processes performed by the information processing apparatus 10 or the like explained above with reference to a flowchart or a sequence diagram in the above-described example embodiments by loading software (a computer program) from the memory 1203 and executing the loaded software. The processor 1202 may be, for example, a microprocessor, an MPU (Micro Processing Unit), or a CPU (Central Processing Unit). The processor 1202 may include a plurality of processors.

The memory 1203 is formed by a combination of a volatile memory and a nonvolatile memory. The memory 1203 may include a storage disposed remotely from the processor 1202. In this case, the processor 1202 may access the memory 1203 through an I/O interface (not shown).

In the example shown in FIG. 17, the memory 1203 is used to store a group of software modules. The processor 1202 can perform processes performed by the information processing apparatus 10 or the like explained above in the above-described example embodiments by loading the group of software modules from the memory 1203 and executing the loaded software modules.

Each of the processors included in the information processing apparatus 10 or the like executes one or a plurality of programs including a group of instructions for causing a computer to perform an algorithm explained above with reference to the drawings.

In the above-described examples, the program can be stored and provided to a computer using any type of non-transitory computer readable media. Non-transitory computer readable media include any type of tangible storage media. Examples of non-transitory computer readable media include magnetic storage media, optical magnetic storage media, CD-ROM (Read Only Memory), CD-R, CD-R/W, and semiconductor memories. Examples of the magnetic storage media include flexible disks, magnetic tapes, and hard disk drives. Examples of the semiconductor memories include mask ROM, PROM (programmable ROM), EPROM (Erasable PROM), flash ROM, and RAM (random access memory). Further, the program may be supplied to a computer by using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Note that the present invention is not limited to the above-described example embodiments, and they can be modified as appropriate without departing from the scope and spirit of the invention.

The whole or part of the example embodiments disclosed above can be described as, but not limited to, the following supplementary notes.

### (Supplementary Note 1)

An information processing apparatus comprising:

a traveling route determination unit configured to determine a traveling route for a first mobile body;

a traveling plan acquisition unit configured to acquire a traveling route for a second mobile body and a radio communication channel used by the second mobile body at each point on the traveling route based on the determined result;

a map information acquisition unit configured to acquire map information indicating, for each part of a facility in which the second mobile body can move, a communication failure area corresponding to the radio communication channel that is used by the second mobile body when the second mobile body is located at that part of the facility; and

a communication channel determination unit configured to determine the communication failure area corresponding to the radio communication channel, caused by the second mobile body in the traveling route for the first mobile body, and determine a radio communication channel available to the first mobile body based on the determined communication failure area.

### (Supplementary Note 2)

The information processing apparatus described in Supplementary note 1, wherein the traveling route determination unit determines a traveling start time and a scheduled traveling end time.

### (Supplementary Note 3)

The information processing apparatus described in Supplementary note 1, wherein the traveling route determination unit determines a shortest route from a current position of the first mobile body to a destination thereof as the traveling route.

### (Supplementary Note 4)

The information processing apparatus described in Supplementary note 1, wherein the map information acquisition unit acquires map information indicating, for each part of a facility in which the first mobile body can move, a communication failure area for at least one radio channel that is available to the first mobile body when the first mobile body is located at that part of the facility.

### (Supplementary Note 5)

The information processing apparatus described in Supplementary note 4, wherein when the communication channel determination unit cannot determine the radio communication channel available to the first mobile body at any of points in the traveling route for the first mobile body, the traveling route determination unit determines the traveling route in such a manner that the first mobile body avoids a communication failure area caused by the second mobile body and a communication failure area caused by the first mobile body does not interfere with communication of the second mobile body.

### (Supplementary Note 6)

The information processing apparatus described in Supplementary note 1, wherein an area inside the facility is defined by dividing the area into a plurality of grids each of which indicates a size in which one mobile body is contained.

### (Supplementary Note 7)

A mobile-body control system comprising:

a first mobile body and a second mobile body, each of which uses a radio communication channel; and

a control apparatus configured to control the first mobile body, wherein the control apparatus comprises:

a traveling route determination unit configured to determine a traveling route for the first mobile body;

a traveling plan acquisition unit configured to acquire a traveling route for the second mobile body and the radio communication channel used by the second mobile body at each point on the traveling route based on the determined result;

a map information acquisition unit configured to acquire map information indicating, for each part of a facility in which the second mobile body can move, a communication failure area corresponding to the radio communication channel that is used by the second mobile body when the second mobile body is located at that part of the facility; and

a communication channel determination unit configured to determine the communication failure area corresponding to the radio communication channel, caused by the second mobile body in the traveling route for the first mobile body, and determine a radio communication channel available to the first mobile body based on the determined communication failure area.

### (Supplementary Note 8)

The mobile-body control system described in Supplementary note 7, wherein the traveling route determination unit determines a traveling start time and a scheduled traveling end time.

### (Supplementary Note 9)

The mobile-body control system described in Supplementary note 7, wherein the traveling route determination unit determines a shortest route from a current position of the first mobile body to a destination thereof as the traveling route.

### (Supplementary Note 10)

The mobile-body control system described in Supplementary note 7, wherein the map information acquisition unit acquires map information indicating, for each part of a facility in which the first mobile body can move, a communication failure area for at least one radio channel that is available to the first mobile body when the first mobile body is located at that part of the facility.

### (Supplementary Note 11)

The mobile-body control system described in Supplementary note 9, wherein when the communication channel determination unit cannot determine the radio communication channel available to the first mobile body at any of points in the traveling route for the first mobile body, the traveling route determination unit determines the traveling route in such a manner that the first mobile body avoids a communication failure area caused by the second mobile body and a communication failure area caused by the first mobile body does not interfere with communication of the second mobile body.

### (Supplementary Note 12)

The mobile-body control system described in Supplementary note 7, wherein an area inside the facility is defined by dividing the area into a plurality of grids each of which indicates a size in which one mobile body is contained.

### (Supplementary Note 13)

An information processing method comprising:

determining a traveling route for a first mobile body;

acquiring a traveling route for a second mobile body and a radio communication channel used by the second mobile body at each point on the traveling route based on the determined result;

acquiring map information indicating, for each part of a facility in which the second mobile body can move, a communication failure area corresponding to the radio communication channel that is used by the second mobile body when the second mobile body is located at that part of the facility; and

determining the communication failure area corresponding to the radio communication channel, caused by the second mobile body in the traveling route for the first mobile body, and determining a radio communication channel available to the first mobile body based on the determined communication failure area.

### (Supplementary Note 14)

The information processing method described in Supplementary note 13, wherein the traveling route, a traveling start time, and a scheduled traveling end time are determined.

### (Supplementary Note 15)

The information processing method described in Supplementary note 13, wherein a shortest route from a current position of the first mobile body to a destination thereof is determined as the traveling route.

### (Supplementary Note 16)

The information processing method described in Supplementary note 13, wherein map information is acquired, the map information indicating, for each part of a facility in which the first mobile body can move, a communication failure area for at least one radio channel that is available to the first mobile body when the first mobile body is located at that part of the facility.

### (Supplementary Note 17)

The information processing method described in Supplementary note 16, wherein when the radio communication channel available to the first mobile body cannot be determined at any of points in the traveling route for the first mobile body, the traveling route is determined in such a manner that the first mobile body avoids a communication failure area caused by the second mobile body and a communication failure area caused by the first mobile body does not interfere with communication of the second mobile body.

### (Supplementary Note 18)

The information processing method described in Supplementary note 13, wherein an area inside the facility is defined by dividing the area into a plurality of grids each of which indicates a size in which one mobile body is contained.

### (Supplementary Note 19)

A program for causing a computer to perform:

a process for determining a traveling route for a first mobile body;

a process for acquiring a traveling route for a second mobile body and a radio communication channel used by the second mobile body at each point on the traveling route based on the determined result;

a process for acquiring map information indicating, for each part of a facility in which the second mobile body can move, a communication failure area corresponding to the radio communication channel that is used by the second mobile body when the second mobile body is located at that part of the facility; and

a process for determining the communication failure area corresponding to the radio communication channel, caused by the second mobile body in the traveling route for the first mobile body, and determining a radio communication channel available to the first mobile body based on the determined communication failure area.

### (Supplementary Note 20)

The program described in Supplementary note 19, wherein the traveling route, a traveling start time, and a scheduled traveling end time are determined.

### (Supplementary Note 21)

The program described in Supplementary note 19, wherein a shortest route from a current position of the first mobile body to a destination thereof is determined as the traveling route.

### (Supplementary Note 22)

The program described in Supplementary note 19, wherein map information is acquired, the map information indicating, for each part of a facility in which the first mobile body can move, a communication failure area for at least one radio channel that is available to the first mobile body when the first mobile body is located at that part of the facility.

### (Supplementary Note 23)

The program described in Supplementary note 22, wherein when the radio communication channel available to the first mobile body cannot be determined at any of points in the traveling route for the first mobile body, the traveling route is determined in such a manner that the first mobile body avoids a communication failure area caused by the second mobile body and a communication failure area caused by the first mobile body does not interfere with communication of the second mobile body.

### (Supplementary Note 24)

The program described in Supplementary note 19, wherein an area inside the facility is defined by dividing the area into a plurality of grids each of which indicates a size in which one mobile body is contained.

Although the present invention is described above with reference to example embodiments, the present invention is not limited to the above-described example embodiments. Various modifications that can be understood by those skilled in the art can be made to the configuration and details of the present invention within the scope of the invention.

This application is based upon and claims the benefit of priority from Japanese patent application No. 2020-112327, filed on Jun. 30, 2020, the disclosure of which is incorporated herein in its entirety by reference.

### REFERENCE SIGNS LIST

### 1 MOBILE-BODY CONTROL SYSTEM

### 5 NETWORK

### 8 ACCESS POINT

### 9 ACCESS POINT

### 10 INFORMATION PROCESSING APPARATUS

### 11 TRAVELING ROUTE DETERMINATION UNIT

### 12 TRAVELLING PLAN ACQUISITION UNIT

### 13 MAP INFORMATION ACQUISITION UNIT

### 14 COMMUNICATION CHANNEL DETERMINATION UNIT

### 100 CONTROL APPARATUS

### 101 AGV CONTROL UNIT

### 102 TRAVELLING PLAN DATABASE

### 103 MAP INFORMATION DATABASE

### 104 TRAVELING INSTRUCTION UNIT

### 105 TRAVELLING PLAN DETERMINATION UNIT

### 1051 TRAVELING ROUTE DETERMINATION UNIT

### 1052 TRAVELLING PLAN ACQUISITION UNIT

### 1053 MAP INFORMATION ACQUISITION UNIT

### 1054 COMMUNICATION CHANNEL DETERMINATION UNIT

### 106 TRANSPORT-VEHICLE INFORMATION DATABASE

### A1, A2, A3 AUTOMATIC GUIDED VEHICLE (TRANSPORT ROBOT)

What is claimed is:

1. An information processing apparatus comprising:
at least one memory storing instructions, and
at least one processor configured to execute the instructions to;
determine a traveling route for a first mobile body;
determine a traveling route for a second mobile body and a radio communication channel used by the second mobile body at each point on the traveling route based on the determined result;
acquire map information indicating, for each part of a facility in which the second mobile body can move, a communication failure area corresponding to the radio communication channel that is used by the second mobile body when the second mobile body is located at that part of the facility; and
determine the communication failure area corresponding to the radio communication channel, caused by the second mobile body in the traveling route for the first mobile body, and determining a radio communication channel available to the first mobile body based on the determined communication failure area.

2. The information processing apparatus according to claim 1, wherein the at least one processor is configured to execute the instructions to determine a traveling start time and a scheduled traveling end time.

3. The information processing apparatus according to claim 1, wherein the at least one processor is configured to execute the instructions to determine a shortest route from a current position of the first mobile body to a destination thereof as the traveling route.

4. The information processing apparatus according to claim 1, wherein the at least one processor is configured to execute the instructions to acquire map information indicating, for each part of a facility in which the first mobile body can move, a communication failure area for at least one radio channel that is available to the first mobile body when the first mobile body is located at that part of the facility.

5. The information processing apparatus according to claim 4, wherein when the radio communication channel available to the first mobile body at any of points in the traveling route for the first mobile body cannot be determined, the at least one processor is configured to execute the instructions to determine the traveling route in such a manner that the first mobile body avoids a communication failure area caused by the second mobile body and a communication failure area caused by the first mobile body does not interfere with communication of the second mobile body.

6. The information processing apparatus according to claim 1, wherein an area inside the facility is defined by dividing the area into a plurality of grids each of which indicates a size in which one mobile body is contained.

7. A mobile-body control system comprising:
a first mobile body and a second mobile body, each of which uses a radio communication channel; and
a control apparatus configured to control the first mobile body, wherein
the control apparatus comprises:
at least one memory storing instructions, and
at least one processor configured to execute the instructions to; travel route determination means for determining a traveling route for the first mobile body;
acquire a traveling route for the second mobile body and the radio communication channel used by the second mobile body at each point on the traveling route based on the determined result;
acquire map information indicating, for each part of a facility in which the second mobile body can move, a communication failure area corresponding to the radio communication channel that is used by the second mobile body when the second mobile body is located at that part of the facility; and
determine the communication failure area corresponding to the radio communication channel, caused by the second mobile body in the traveling route for the first mobile body, and determine a radio communication channel available to the first mobile body based on the determined communication failure area.

8. The mobile-body control system according to claim 7, wherein the at least one processor is configured to execute the instructions to determine a traveling start time and a scheduled traveling end time.

9. The mobile-body control system according to claim 7, wherein the at least one processor is configured to execute the instructions to determine a shortest route from a current position of the first mobile body to a destination thereof as the traveling route.

10. The mobile-body control system according to claim 7, wherein the at least one processor is configured to execute the instructions to acquire map information indicating, for each part of a facility in which the first mobile body can move, a communication failure area for at least one radio channel that is available to the first mobile body when the first mobile body is located at that part of the facility.

11. The mobile-body control system according to claim 9, wherein when the radio communication channel available to the first mobile body at any of points in the traveling route for the first mobile body cannot be determined, the at least one processor is configured to execute the instructions to determine the traveling route in such a manner that the first mobile body avoids a communication failure area caused by the second mobile body and a communication failure area caused by the first mobile body does not interfere with communication of the second mobile body.

12. The mobile-body control system according to claim 7, wherein an area inside the facility is defined by dividing the area into a plurality of grids each of which indicates a size in which one mobile body is contained.

13. An information processing method comprising:
determining a traveling route for a first mobile body;
acquiring a traveling route for a second mobile body and a radio communication channel used by the second mobile body at each point on the traveling route based on the determined result;
acquiring map information indicating, for each part of a facility in which the second mobile body can move, a communication failure area corresponding to the radio communication channel that is used by the second mobile body when the second mobile body is located at that part of the facility; and
determining the communication failure area corresponding to the radio communication channel, caused by the second mobile body in the traveling route for the first mobile body, and determining a radio communication channel available to the first mobile body based on the determined communication failure area.

14. The information processing method according to claim 13, wherein the traveling route, a traveling start time, and a scheduled traveling end time are determined.

15. The information processing method according to claim 13, wherein a shortest route from a current position of the first mobile body to a destination thereof is determined as the traveling route.

16. The information processing method according to claim 13, wherein map information is acquired, the map information indicating, for each part of a facility in which the first mobile body can move, a communication failure area for at least one radio channel that is available to the first mobile body when the first mobile body is located at that part of the facility.

17. The information processing method according to claim 16, wherein when the radio communication channel available to the first mobile body cannot be determined at any of points in the traveling route for the first mobile body, the traveling route is determined in such a manner that the first mobile body avoids a communication failure area caused by the second mobile body and a communication failure area caused by the first mobile body does not interfere with communication of the second mobile body.

18. The information processing method according to claim 13, wherein an area inside the facility is defined by dividing the area into a plurality of grids each of which indicates a size in which one mobile body is contained.
